(19) United States
(12) Patent Application Publication
(10) Pub. No.: US 2020/0342554 A1
(43) Pub. Date: Oct. 29, 2020

(54) System of providing services to and from college students anonymously composed of completing assignments and services through the use of portable computing devices for the purpose of but not limited to review and/or comparisons

(71) Applicants: Jeffrey Stephen Tauber, White Lake, NY (US); Nour Alddin Omar Almasri, New York, NY (US); Justin Jeffery Lynch, Tampa, FL (US)

(72) Inventors: Jeffrey Stephen Tauber, White Lake, NY (US); Nour Alddin Omar Almasri, New York, NY (US); Justin Jeffery Lynch, Tampa, FL (US)

(21) Appl. No.: 16/395,894

(22) Filed: Apr. 26, 2019

(51) Int. Cl. G06Q 50/20; G06Q 20/12; G06Q 30/06

(52) U.S. Cl. CPC G06Q 50/20; G06Q 30/0641; G06Q 20/1235

(57) ABSTRACT

The present invention is a system and method of allowing college students to have means of exchange in services which includes but is not limited to essays, assignments, presentations and all academic property that is presented in the detailed description to the clients that request it through a computer readable medium capable of executing the actions to be used through an interface on any computing device.

This process of trade in our current invention includes transactions involving the sales of rights and ownership of essays and assignments for monetary value in which our administered system would own any and all information included in the academic property.

This method and system of the present invention involves student verification. The principal purpose for a transaction through the use of our system is revision and further advancement of the client's ideas. The license we provide to the student is of limited use as the state of the laws in place for the use of this academic property; the administered system presumes the legal copyright.

### BACKGROUND OF THE INVENTION

### Field of the Invention

The present invention relates to an interface that provides an exchange of services in the form of assignment writings and preparations in exchange for monetary value to be used between college students selecting between the services of either “post an assignment” or “complete an assignment” in favor of assistance purposes.

### SUMMARY OF THE INVENTION

The present invention provides a system allowing an exchange of services and assignments for assistance purposes between students attending higher education institutions.

The present invention also includes the system of having clients verified and authenticated as students of higher education institutions.

According to the features of our present invention, the system verifies members personal information required for registration as a client of our system through a validation email sent to the college email provided by the client.

The system provided to the registered clients after logging in gives the clients a choice of a selection of services. The selections of services include but are not limited to the choice of either “post an assignment” or “complete an assignment”.

The choice to “post an assignment” in our current invention is the service wherein a client posts the details of an assignment being requested to be completed by a fellow registered client within our system.

The choice to “complete an assignment” in our present invention refers to the service of searching our system for a preferred assignment or service the client finds acceptable to complete for a registered client within our system.

According to another aspect of the present invention, there is provided through the use of any computing device a computer program for executing the action of selecting a service by our system by registered clients through a computer readable recording medium.

### BRIEF DESCRIPTION OF THE DRAWINGS

The features and advantages of our present invention will be explained thoroughly in the detailed section of this patent in relation to the drawings above in which:

FIG. 1 represents a flowchart sequence of the process in which a client uses the interface to log on or to register him/herself to our interface for the use of services provided.

FIG. 2 is an image of the screen of which allows the client either to log on to our platform or go about the registration process.

FIG. 3 is an image of the screen representing our current invention which contains a series of hyperlinks that allow text to be sent to us. The text to be inputted includes the user's login information along with personal information.

FIG. 4 is a representation of the current screen of our invention that allows a client a selection of our services. This screen shows our clients two options provided for services in addition to a disclaimer notifying our clients of the sole purpose of our platform.

FIG. 5 is an image of the screen that brings about a pop up that provides hyperlinks to a variety of pages to accommodate the client with editing parts of his profile or viewing prior transactions.

FIG. 6 is a flowchart diagram representing the process of the two services in addition to the sequenced process of the services offered by our current invention.

FIG. 7 is an image of the screen that follows the selection of requesting a service. This screen pertains to describing with details the service to be requested.

FIG. 8 is an image of the screen that follows the selection of completing a service. This image is an example of the screen viewed by the client to select a service to complete from a list of services requested.

FIG. 9 is an image of a detailed description of a service of which is being requested and of which is chosen to be completed. The image is just an example screen of what a service may appear to be.

### DETAILED DESCRIPTION OF THE INVENTION

From this point on, this section will descriptively apply to elaborating the present invention with reference to the attached drawings.

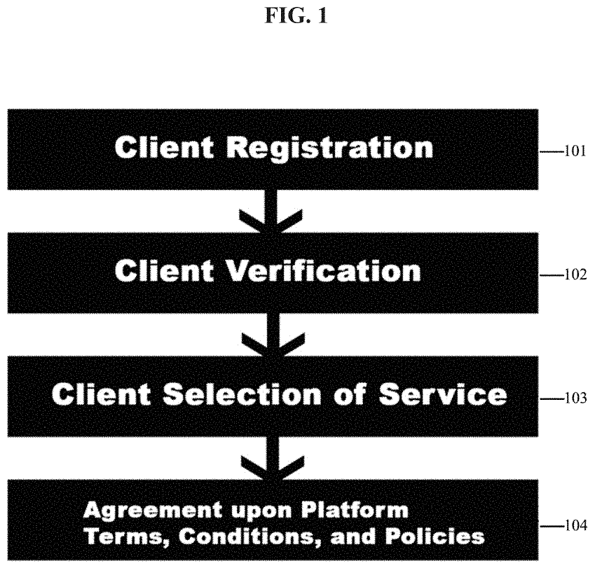

FIG. 1 is a flowchart sequence of the process in which a client uses the interface to log on or to register him/her self to our interface for the use of services provided.

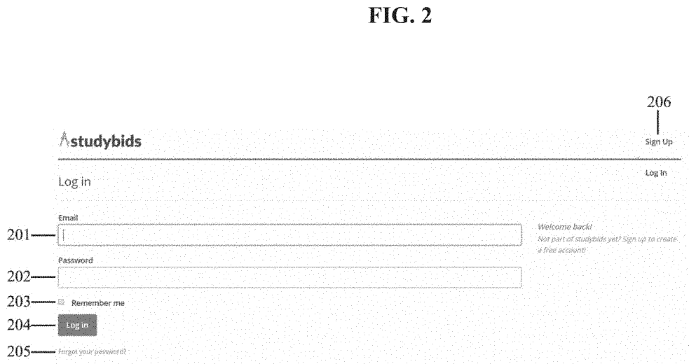

The method of our present invention starts by entering a portal which could include any image or logo to the company's preference, Unit 101 references to the client's subjection of use of the provided system through a mean of logging on to our system as an already registered clientele or registering to the system as a new client portrayed in FIG. 2.

In reference to FIG. 1, unit 102 refers to an embedded system of images with hyperlinks used for inputting and exporting information involving academic property with a verified community.

The system is primarily centralized through the use of portable computing devices including but not limited to an application function and/or browser option.

Client Registration is completed only through confirmation of clientele verification referring to Unit 102 of the flowchart. The current system requires a functional email address associated with a higher education institution asserting the client as a student of the selected institution.

The present invention of our system follows with unit 103 with a selection of choices of services for a client to select.

Unit 104 refers to the step following the selection of a choice of services wherein the selection of a service must adhere to the terms, conditions, and policies which are to be agreed upon before any further steps can be taken.

FIG. 2 is an image of the screen of which allows the client access to our platform through logging on as an existing client or having to undergo the procedure to register as a new client.

In our present invention, input unit 201 refers to an accredited email address box that is applicable and allows the input of text. This is where the client will input their designated email address they had selected when registering as a client to our system.

The password section (reference to input unit 202 of images) will be followed by the email address box and is where their created password will be Inputted. This information from both unit 201 and unit 202 can be recorded by the user's system if desired by pressing the applicable image entry box.

In accordance to our present invention, input unit 204 refers to the submission of previous details by using the submit button to confirm correct details provided by the client.

Input unit 205 refers to the potential situation in which the user loses their password or cannot remember the accounts username. The embedded link to be pressed will redirect the client to a browser page in which it will be processed.

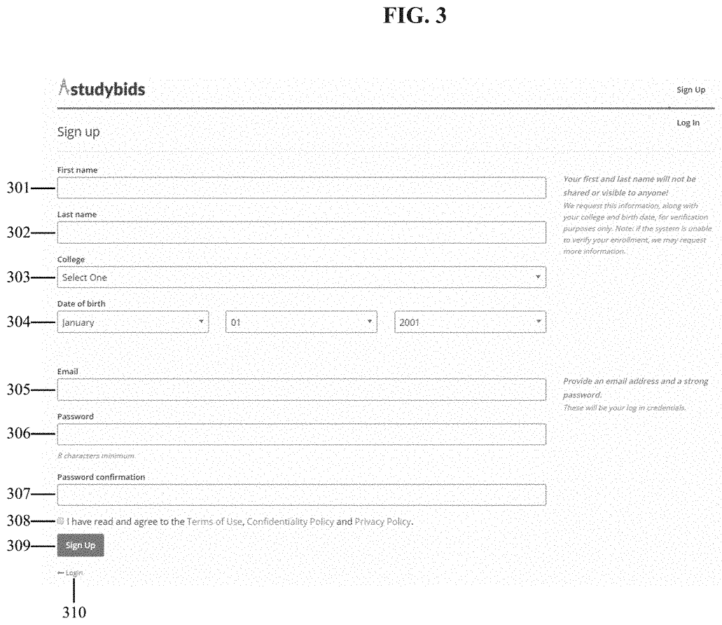

FIG. 3 represents an image of the screen of our current invention containing a series of hyperlinks that allow text to be sent to us. The text to be inputted includes the user's login information along with personal information.

Referring back to FIG. 2, input unit 206 refers to the initiation of the registration procedure leading to the creation of an account with our service in which the client will press the signup button.

Upon selection of client registration, in reference to unit 206, client will be presented with a page permitting the client registration through the entry of information in the designated units of which input unit 301 allows entry of data referring to the client's applicable legal first name.

Following the entry of client information in input unit 301, input unit 302 allows the client to enter information in reference to the client's applicable legal last name.

Furthermore, the registration section is followed by the college verification (reference to 303 of images) which is a drop down with a list of current universities and colleges available within our present system.

The registration section includes further personal verification in which input unit 304 provides the client with drop down lists allowing the client access to select their applicable legal date of birth composing of month, day and year of birth.

Following the sign-up button to initiate registration, the potential client is presented with an area where their designated email address which is selective to themselves is to be inputted and is displayed in input unit 305.

In addition to this, input unit 305 refers to the process of email verification in accordance to the client's college email associated with the college's given email domain to be inputted wherein a confirmation email will be sent to the client notifying the client of prospective client verification success, status pending, or failure.

In accordance with the college registration page, input unit 306 requires the client to customize a selective password no less than 8 characters to be inputted in the designated input area. Input unit 307 follows to serve as further authentication by providing the client with a designated area to reenter the previously customized password entered in input unit 306.

Input unit 308 is an image of the box that allows a client to finalize registration by clicking the image box to confirm that the client has read and agreed fully to our terms, conditions, and policies.

Furthermore, Input unit 308 provides hyperlinks to our terms, conditions, and policies of which the client must agree to in order to proceed to the next screen of our platform.

After they have read completely through all of our policies and understand what they are agreeing to, they will be able to sign up (reference to 309 of images) and further the process.

By selecting Input Unit 310, the client will be redirected back to the page referred to in FIG. 2.

Referring back to FIG. 1, after the potential client has provided their personal information and it has been confirmed as verified by the server in use, they may then log in to the system (reference to input unit 102 of FIG. 1).

Furthermore, referring back to FIG. 1, after being verified by the server in use the client is then told in our present invention to “choose one of the following:” (reference to 103 of images) to either 1) compose or exchange a piece of academic property further giving us the rights listed as “POST an assignment” (Reference to input unit 420 of images), Or 2) Solve academic property in which said property is received given there is an authorized form of a limited license listed as “Complete an assignment” (Reference to input unit 410 of images).

In reference to input unit 430, the current invention consists of a designated area that contains a short description of an assignment to be completed. This description of our current intervention includes but is not limited to the assignment's title and/or topic, compensation, date of which the assignment is due, and the status of the assignment according to the current system.

In the upper right-hand corner of the figure in reference to input unit 440, a hyperlink exists in our current system to redirect the client to a list of assignments with an existing status of posted.

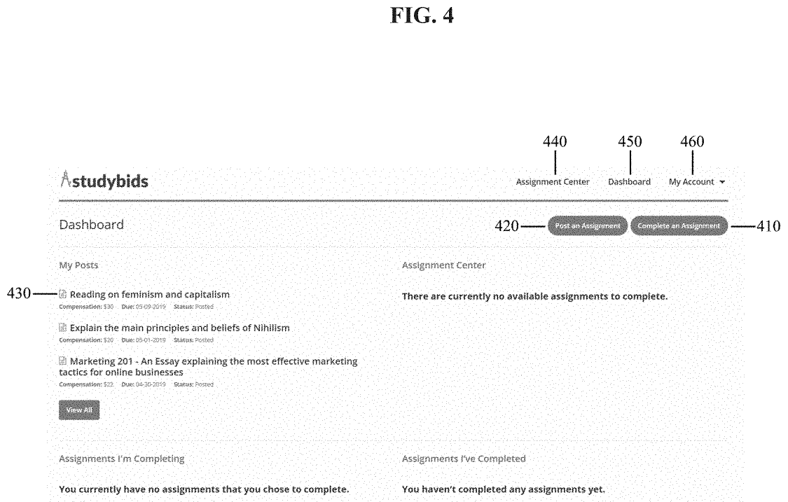

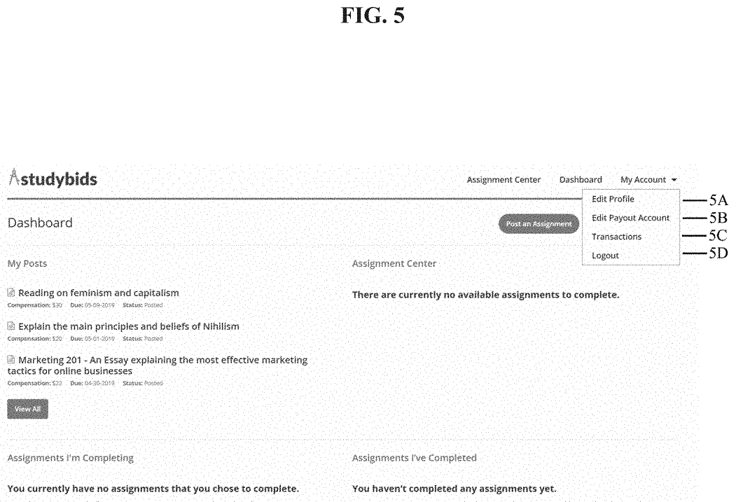

FIG. 5 is an image of the screen that brings about a pop up that provides hyperlinks to our list of services that allow a client to select a variety of links that permit the client to alter or check aspects of the client's selected settings. This screen is brought about by clicking the input unit 460 in reference to FIG. 4 and allows the selection of hyperlink 5A “Edit Profile”, 5B “Edit Payout Account”, 5C “Transactions”, and 5D “Logout”.

In reference to FIG. 5, Input unit 5D prompts for the current inventions operating system to disconnect the user forcing them to log off by redirecting the client from the client's current screen of the system to the “Logout” screen.

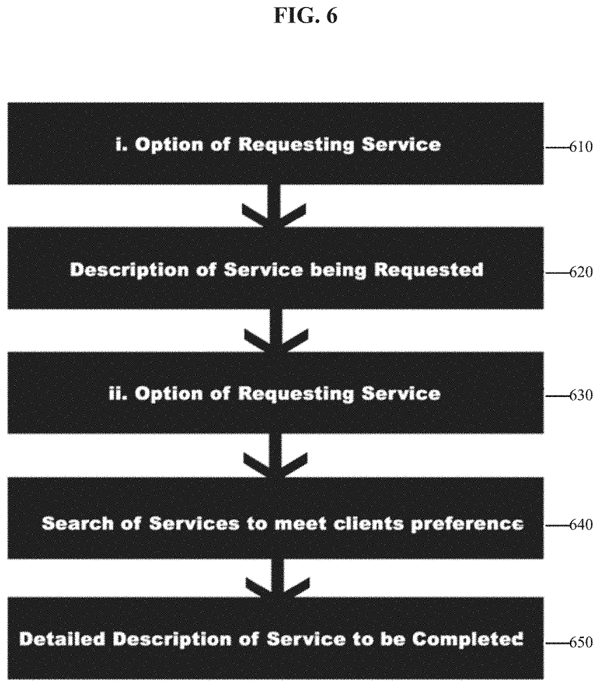

FIG. 6 is a flowchart diagram representing the process of the two services in addition to the sequenced process of the services offered by our current invention.

Once our policies have been completely read and understood (refer to 610 of images), you will then fill in the details (refer to 620 of images) of the service requested if the option of requesting a service is selected.

Reference unit 630 refers to the option of selecting to complete a service in which the client will then be able to search an assignment or service to complete (reference unit 640).

Afterwards, in reference to unit 650, a short-detailed description of the assignment or service to be completed will appear.

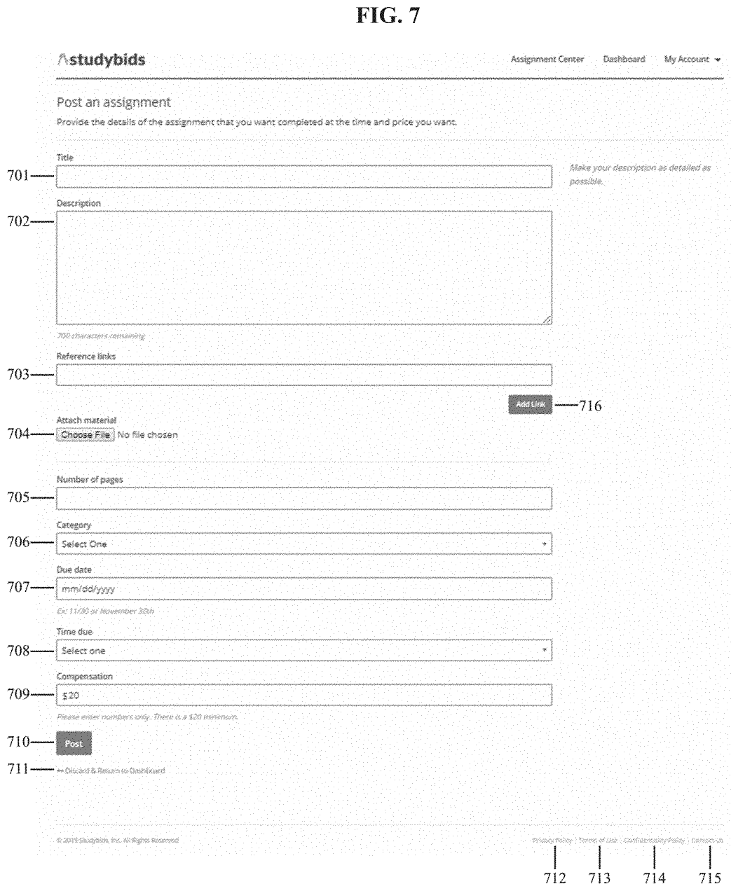

FIG. 7 is an image of the screen that follows the selection of posting an assignment. This screen pertains to describing with details the service to be requested.

In reference to FIG. 7, when requesting an assignment, the user begins by inputting the title of the service in the text box (refer to 701 of images).

Input unit 702 refers to a detailed description of the assignment posted by the client and it is archived by inputting text into the designated hyperlinked text box.

Input unit 703 refers to the Referenced Links the client may provide to aid the assignment process and it is archived by inputting text into the designated hyperlinked text box below “Referenced Links”.

Unit 704 is an optional part of the system of which allows the user to attach and/or upload any documents or directions to aid the provider with the assignment or service to be completed through the hyperlinked box for the materials.

In addition to this, on the same page, reference unit 705 refers to the next box that is located on the current page or image of which is the length of the service or assignment itself which is to be specific.

Moreover, Input Unit 706 allows the user to select the category under which the assignment's subject is most relevant.

Also, the client then marks a due date and time for the assignment to be in their possession (refer to 707 and 708 of images).

To complete the request the client then will set a price (refer to 709 of images) for the assignment which is inputted into the textbox designated as compensation. The client can then press the post button (refer to 710 off images) sending the information to the system.

In reference to FIG. 7, our current system consists of a hyperlink that allows a user to discard the assignment by pressing on input unit 711. FIG. 4 is an example of the screen of our current system of which the user is redirected to after clicking input unit 711.

Input Unit 712 represents a link that redirects the clients of our present invention from the screen referred to as FIG. 7 to the current privacy policy. This is followed by input unit 713 representing a hyperlink to the current system's terms of use, and input unit 714 which is a hyperlink to the current confidentiality policy of our present invention.

Furthermore, input unit 715 when prompted displays a pop-up box to our clients with the appropriate measures to reach the administrators of our current invention.

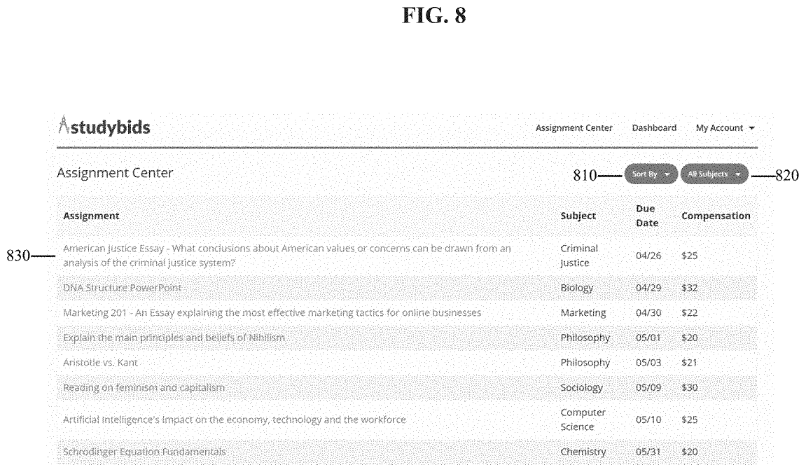

FIG. 8 is an image of the screen that follows the selection of seeking a service. This image is an example of the screen viewed by the client to select a service to complete from a list of services requested.

Referring to FIG. 8, if the client wants to be the provider of the academic service, they would then start by selecting the option to sort the assignments referred to as “Sort By” (refer to 810 of images) prompting a drop down box and filtering information by “All Subjects” (refer to 820 of images) through our system to select desired subjects or topics and refine the search.

Furthermore, a list of assignments or services is displayed (refer to 830 of images) before the user as the system presents related offers.

In addition to this, the assignment or service is listed individually stating the assignment, subject of said assignment, date on which it is due to the client, and the compensation.

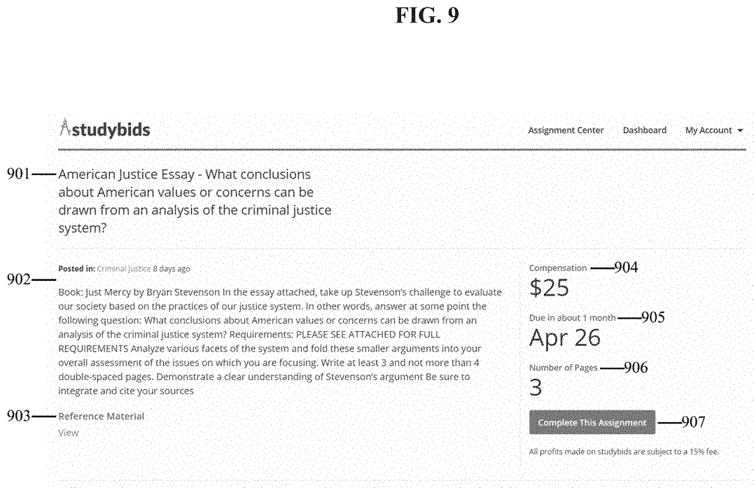

FIG. 9 is an image of a detailed description of a service of which is being requested and of which is chosen to be completed. The image displayed is an example screen of what a service may appear to be to the user.

The Title is located at the head of the page (refer to 901 of images). The title is to clarify the essential subject around which the assignment or service is centralized.

Unit 902 is the details box of which states the type of assignment, and any additional information or notes serving as supplementary information to define the assignment.

Followed by the “Reference Material” (refer to 903 of images) hyperlinked box that once selected or pressed will display the attached documents available for download.

Next is the compensation (refer to 904 of images) of the assignment requested set by the client requesting the assignment.

The official due date (refer to 905 of images) refers to the date the client needs the provider to turn in the product.

The number of pages (refer to 906 of images) refers to the length in pages of said assignment requested to be completed.

The transaction is memorialized by pressing the “complete this assignment” (refer to 907 of images) button at the end of the page in which the provider understands and accepts all of the client's needs and requests.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

It is contemplated for embodiments described herein to extend to individual elements and concepts described herein, independently of other concepts, ideas or system, as well as for embodiments to include combinations of elements recited anywhere in this application. Though embodiments are described in detail herein with reference to the associated drawings, it is to be comprehended that the invention is not limited to those specific embodiments. As such, many modifications and variations will be apparent to practitioners skilled in this art. Accordingly, it is intended that the extent of the invention be defined by the following claims and their equivalents. Moreover, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1) An application system in which a service is provided in order to exchange limited copyright of intellectual property in the form of academic property previously owned by clients and would be transferred at the will of the principal.
What is outputted to the customer is a limited license of said intellectual property which is delivered through the same application system.
The figures located down below involve the principal's login screen, account creation screen, transaction selection, business search and product transfer.

2) In accordance with claim 1, the service providing system of the principal's login screen is in reference to their assigned system identification, with the ability to begin the steps to password or username retrieval.

3) The option of selecting a choice between completing or requesting a service is in reference to the screen in which clients will manually decide their position in the client relationship.
It is divided between two categories:
A) Provide and or compose the form of academic property requested or
B) Receive the form of academic property in exchange for monetary compensation.

4) The service providing system, in reference to claim 3, will also require the user to completely review and accept that they understand and will lawfully abide by our terms of service and policies.

5) The client registration process required for claim 1 pertains to the information to be provided to the system of which includes:
i. Input of first name and last name as applicable to the client.
ii. Input of date of birth of the client currently attempting to sign up.
iii. Selection of the higher education institute that the client is currently attending.
iv. Input of the email address associated with the higher education institute that the client is enrolled in along with a private password.
This information will not be available to the public's vision unless directly mandated by the current owners of the system in which they reserve the rights to policy changes.
This information to be inputted and sent to our system is to be provided only by the client who is seeking to register to our system and is only to be a student of a higher education institute.

6) A client verification system in accordance to claim 5. This client verification system is applied by entering a password in addition to password confirmation. This to be directly followed by confirmation of reading and agreeing to the system's present terms of use, confidentiality policy, and privacy policy.

7) The service providing system, in reference to A) of claim 3 or the “poster”, begins with inputting the following information in our hyperlink text boxes:
i. Title line which refers to the exact topic and the course focus.
ii. Is a detailed description of the academic property, this includes but is not limited to any due dates, specifications, type of language choices, syntax, etc.
iii. Is in reference to a link's text box in order to support clients in completing an assignment of which this feature exists as an optional addition.
iv. Is In reference to the system's permissible access to its present client's database in regard to uploading and attaching supportive documents.
v. Is in reference to the length or pages required for the academic property to be completed.
vi. Refers to the subject of which the assignment to be requested is categorized within the system.
vii. Directly reflects the client's selection of a date that represents the exact time in which the client agrees to adhere to the systems terms in receiving a completed assignment as per requested.
viii In reference to the client's selection of a reasonable compensation for the agreed upon and chosen assignment to be completed.

8) The service providing system in reference to B) of claim 3 or the “completing an assignment”, begins with selecting from the information provided by the present system to aid the client in searching for an assignment.
At the top of the image page there exists several options within the systems header for the purpose of filtering through the services that currently are listed by clients requesting a service, this is in connection with finding a suitable client to meet the preferences of the client requesting a service in regard to a successful completion and transaction.
The selection area of our present system can pertain to but is not limited to the topic or subject of the service, date on which the service is due, amount of compensation proposed for the service, and the length of the service.
Once filters on the search have been the current, offers will be displayed in front of the client for further explanation.

9) A service providing system in which all clients exist in our system as anonymous to other clients to secure identity and safety of present clients in our current system. This is performed by prohibiting exchange of personal information between the clients using the system to either provide “complete an assignment” or request a service “post an assignment”

10) The computer recording reading medium having recorded thereon a computer program for executing a service providing system in reference to claim 5 which allows the user to register to our system. This is necessary to access the options of either requesting a service or assignment to be completed or selecting the option of completing an assignment or service in compensation of monetary value. The computer recording reading medium composes the code generated for the interface which pertains to but is not limited to the interface of our current system via mobile application or website through the use of any computing device.

11) The computer readable recording medium in reference to claim 3 requiring code generated to perform the actions of selecting a service presented by the system of either the option of completing an assignment and/or service or the option to request a service and/or assignment.
